(19) United States
(12) Patent Application Publication
(10) Pub. No.: US 2025/0053827 A1
(43) Pub. Date: Feb. 13, 2025

(54) SYSTEMS AND METHODS FOR DECISION TREE CONSTRUCTION AND UPDATE USING QUANTUM ALGORITHMS

(71) Applicant: JPMORGAN CHASE BANK, N.A., New York, NY (US)

(72) Inventors: Romina YALOVETZKY, Buenos Aires (AR); Niraj KUMAR, Amsterdam (NL); Changhao LI, New York, NY (US); Marco PISTOIA, Amawalk, NY (US)

(21) Appl. No.: 18/448,662

(22) Filed: Aug. 11, 2023

(51) Int. Cl. G06N 5/01; G06N 10/60

(52) U.S. Cl. CPC G06N 5/01; G06N 10/60

(57) ABSTRACT

Systems and methods for decision tree construction and update using quantum algorithms are disclosed. A method may include: receiving, by a classical computer program, a dataset comprising a plurality of training examples, each of the plurality of training examples having a plurality of features; loading, by a classical computer program, the dataset into a quantum accessible data structure; providing, by the classical computer program, the quantum accessible data structure to a quantum computer, wherein the quantum computer is configured to perform quantum estimation of a Pearson correlation coefficient on the dataset in the quantum accessible data structure to create a weighted dataset; clustering, by the classical computer program and the quantum computer, each of the plurality of training examples in the weighted dataset into one of a plurality of clusters; and selecting, by the classical computer program, a label for each of the plurality of clusters.

### BACKGROUND OF THE INVENTION

### 1. Field of the Invention

Embodiments relate to systems and methods for decision tree construction and update using quantum algorithms.

### 2. Description of the Related Art

Classifying data is central to many applications. Despite the widespread success of Deep Neural Networks, simple decision-tree-based models have continued to be competitive, because of the simplicity of the models and its explainability. The optimal construction of decision trees is proven to be an NP-complete problem. Consequently, many greedy based local search methods have been devised in classical computing to construct good decision trees. For a given dataset with N training examples and d features, these methods often scale polynomially in both N and d, which limits the scalability of these models in the big data regime, particularly when N is in the range of millions-billions.

### SUMMARY OF THE INVENTION

Systems and methods for decision tree construction and update using quantum algorithms are disclosed. In one embodiment, a method for decision tree construction using quantum algorithms may include: (1) receiving, by a classical computer program, a dataset comprising a plurality of training examples, each of the plurality of training examples having a plurality of features; (2) loading, by a classical computer program, the dataset into a quantum accessible data structure; (3) providing, by the classical computer program, the quantum accessible data structure to a quantum computer, wherein the quantum computer is configured to perform quantum estimation of a Pearson correlation coefficient on the dataset in the quantum accessible data structure to create a weighted dataset; (4) clustering, by the classical computer program and the quantum computer, each of the plurality of training examples in the weighted dataset into one of a plurality of clusters; and (5) selecting, by the classical computer program, a label for each of the plurality of clusters.

In one embodiment, the dataset further may include a plurality of labels.

In one embodiment, the quantum accessible data structure may be stored in quantum read-only memory and may be accessed via superposition.

In one embodiment, the quantum computer stores the training examples in the quantum accessible data structure as amplitude encoded quantum states.

In one embodiment, the Pearson correlation coefficient may be estimated between each feature vector in the quantum accessible data structure and a target label, wherein each feature vector may include the features for each training example.

In one embodiment, the quantum computer estimates the Pearson coefficient using the SWAP test and amplitude amplification.

In one embodiment, the step of quantum clustering on the weighted dataset may include: selecting, by the classical computer program, initial centroids for the weighted dataset and storing the centroids in the quantum accessible data structure; storing, by the classical computer program, the initial centroids in the quantum accessible data structure; and communicating, by the classical computer program, the quantum accessible data structure with the initial centroids to the quantum computer, wherein the quantum computer is configured to estimate a distance of each training example in the weighted dataset to the initial centroids, to assign each training example to one of a plurality of clusters based on the distances, and to update the initial centroids by averaging the training examples in each cluster.

In one embodiment, the quantum computer may be configured to repeat the estimating, the assigning, and updating until a maximum number of iterations has occurred or convergence is achieved.

In one embodiment, the method may also include: receiving, by the classical computer program, a new dataset comprising a plurality of new training examples, each of the plurality of new training examples having a plurality of new features; loading, by a classical computer program, the new dataset into the quantum accessible data structure; providing, by the classical computer program, the quantum accessible data structure to a quantum computer, wherein the quantum computer is configured to perform quantum estimation of a new Pearson correlation coefficient on the dataset in the quantum accessible data structure to create a new weighted dataset; supervised clustering, by the classical computer program and the quantum computer, the training examples and the new training examples in the new weighted dataset into a plurality of clusters; and selecting, by the classical computer program, a new label for each of the plurality of clusters.

According to another embodiment, a system may include: a classical computer executing a classical computer program; and a quantum computer in communication with the classical computer program. The classical computer program is configured to receive a dataset comprising a plurality of training examples, each of the plurality of training examples having a plurality of features, to load the dataset into a quantum accessible data structure, and to provide the quantum accessible data structure to the quantum computer; the quantum computer is configured to perform quantum estimation of a Pearson correlation coefficient on the dataset in the quantum accessible data structure to create a weighted dataset, and to perform supervised quantum clustering of each of the plurality of training examples in the weighted dataset into one of a plurality of clusters; and the classical computer program is configured to select a label for each of the plurality of clusters.

In one embodiment, the dataset further may include a plurality of labels.

In one embodiment, the quantum accessible data structure may be stored in quantum read-only memory and may be accessed via superposition.

In one embodiment, the quantum computer may be configured to store the training examples in the quantum accessible data structure as amplitude encoded quantum states.

In one embodiment, the Pearson correlation coefficient may be estimated between each feature vector in the quantum accessible data structure and a target label, wherein each feature vector may include the features for each training example.

In one embodiment, the quantum computer estimates the Pearson coefficient using the SWAP test and amplitude amplification.

In one embodiment, the classical computer program is further configured to select initial centroids for the weighted dataset and storing the centroids in the quantum accessible data structure, to store the initial centroids in the quantum accessible data structure, and to communicate the quantum accessible data structure with the initial centroids to the quantum computer, and the quantum computer is further configured to estimate a distance of each training example in the weighted dataset to the initial centroids, to assign each training example to one of a plurality of clusters based on the distances, and to update the initial centroids by averaging the training examples in each cluster.

In one embodiment, the quantum computer may be configured to repeat the estimating, the assigning, and updating until a maximum number of iterations has occurred or convergence is achieved.

In one embodiment, the classical computer program may be further configured to receive a new dataset comprising a plurality of new training examples, each of the plurality of new training examples having a plurality of new features, to load the new dataset into the quantum accessible data structure, and to provide the quantum accessible data structure to a quantum computer, wherein the quantum computer is configured to perform quantum estimation of a new Pearson correlation coefficient on the dataset in the quantum accessible data structure to create a new weighted dataset; the quantum computer is further configured to perform supervised clustering of the training examples and the new training examples in the new weighted dataset into a plurality of clusters; and the classical computer program is further configured to select a new label for each of the plurality of clusters.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for decision tree construction and update using quantum algorithms according to an embodiment;

FIG. 2 illustrates a method for decision tree construction and update using quantum algorithms according to an embodiment;

FIG. 3 depicts an exemplary computing system for implementing aspects of the present disclosure.

### DETAILED DESCRIPTION OF PREFERRED EMBODIMENTS

Embodiments relate to systems and methods for decision tree construction and update using quantum algorithms.

Embodiments may include a quantum decision-tree algorithm with an exponential speedup in the number of training samples (N) over classical methods for constructing and updating trees. For example, a multi-class dataset may have N training examples with d features. Each training example may be assigned a label from the class. The training examples may be used to train the decision tree and obtain its construction in order to classify new data.

Given access to a quantum accessible data structure, embodiments may load the classical data (e.g., the training data) to a quantum computer. Using the training example, embodiments may estimate the Pearson correlation coefficient on the quantum computer, which is a metric to measure the linear correlation between each feature in the dataset and the labels. This quantum method has an exponential speedup over existing classical techniques for estimating this coefficient.

With the Pearson coefficient, embodiments may weight each feature in the dataset, thereby ensuring that label information is incorporated into the training (e.g., supervised training). An efficient supervised quantum clustering method using the unsupervised clustering results may cluster the weighted dataset into k disjointed sets or clusters that may be characterized by a centroid that is the average of all of the points in the cluster. The clustering of the data is performed by the quantum computer, and may be based on the Euclidean distance or fidelity between the quantum states that represent the training samples and the centroids of the clusters.

Clustering is a technique that was originally designed for unsupervised learning, where the data does not have any labels and the objective is to cluster the data based on the closeness between the data points. The goal of a decision tree is to reduce the label class impurity of the current node as much as possible. These two goals do not necessarily align, so to reconcile these goals, label information may be incorporated into the training data before clustering.

Each training example may be assigned to the cluster having the closest centroid. The algorithm starts at a root node, where the examples are multiplied by the Pearson correlation coefficient. The weighted examples are clustered using quantum clustering and each weighted example is assigned to a cluster. To expand the tree, for each cluster, further clustering may be performed on the training examples in the cluster. This operation may be repeated until a stopping criterion is achieved, or the tree depth reaches a maximum set depth T.

The result is a tree of clusters, with each cluster being a leaf node of the tree. Then, for each leaf node, a majority label value, which is the label corresponding to the label for a majority of the samples in the leaf node, may be selected. This results in a decision tree with which the classical computer can evaluate and/or classify new data based on closeness to the centroids on the path from the root node to the leaf node.

Embodiments may provide the following technical advantages. The tree construction may be done with a time complexity that is of the order polynomial in logarithm of N, where N is the number of training samples. Assuming access to a quantum accessible data structure, which may be stored in a quantum read only memory and accessed via superposition, the proposed method for quantum tree construction has an exponential speedup over existing classical methods for tree construction. This allows for training with large datasets, which improves the accuracy of the classification, a metric of how well the model classifies new data.

In embodiments, a quantum accessible data structure may be either a classical circuit read only memory data structure or a random access memory structure that may have quantum access to either by individual index query or via quantum index superposition query. In classical computing, to get access to the element stored in the memory, the quantum accessible data structure may be queried by the index corresponding to that memory. In quantum computing, all the memory elements in superposition may be queried by querying the quantum accessible data structure with a superposition of indices.

Embodiments may incorporate information about the labels, thereby making the algorithm a supervised learning algorithm, which improves the accuracy of the model over the case of not weighting the data with the Pearson correlation.

It should be noted that the developed quantum algorithm for estimation of the Pearson correlation may be applicable to other use cases besides the construction of a decision tree.

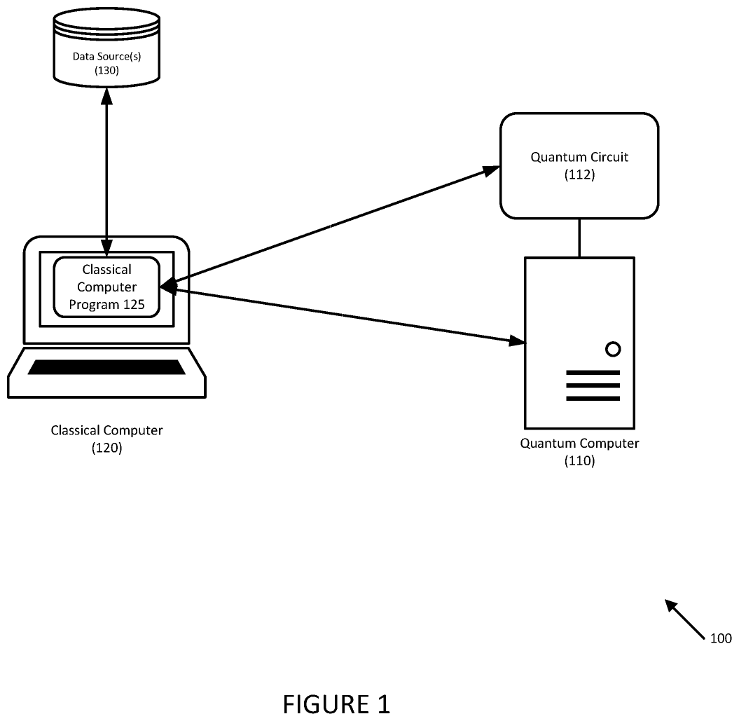

Referring to FIG. 1, a system for decision tree construction using quantum algorithms is disclosed according to an embodiment. System 100 may include quantum computer 110 that may execute quantum circuit 112. Quantum computer 110 may be a device that performs quantum computations, such as those based on the collective properties of quantum states including superposition, interference, and entanglement.

Classical computer 120 may be any suitable general purpose computing device, including servers, workstations, desktop, notebook, laptop, or tablet computers, etc. For example, classical computer 120 may be a microprocessor-based device. Classical computer 120 may interface with quantum circuit 112 using classical computer program 125, which may provide input to, and receive output from, quantum computer 110. In one embodiment, classical computer program 125 may generate one or more quantum circuits 112, may transpile the quantum circuit(s) 112 to machine-readable instructions, and may then send the transpiled circuit(s) 112 to quantum computer 110 for execution. Classical computer program 125 may also receive the results of the execution of the one or more quantum circuits 112.

Data source(s) 130 may include one or more sources of data. For example, data source(s) 130 may provide input data, such as training data. In embodiments, the decision tree may be used to classify a certain type of event (for example, credit card transactions). For example, the data may include a number of training examples containing historical data, such as information about previous events, and labels, or classifications, for those training examples. In the credit card example, the training example may include features such as the cardholder's name, age, etc. These events have already been classified, in most of the cases, by a person, and they have assigned a label (e.g., fraud or not fraud).

It should be noted that the training examples are not limited to credit card transactions. Other training examples for other events may be used as is necessary and/or desired.

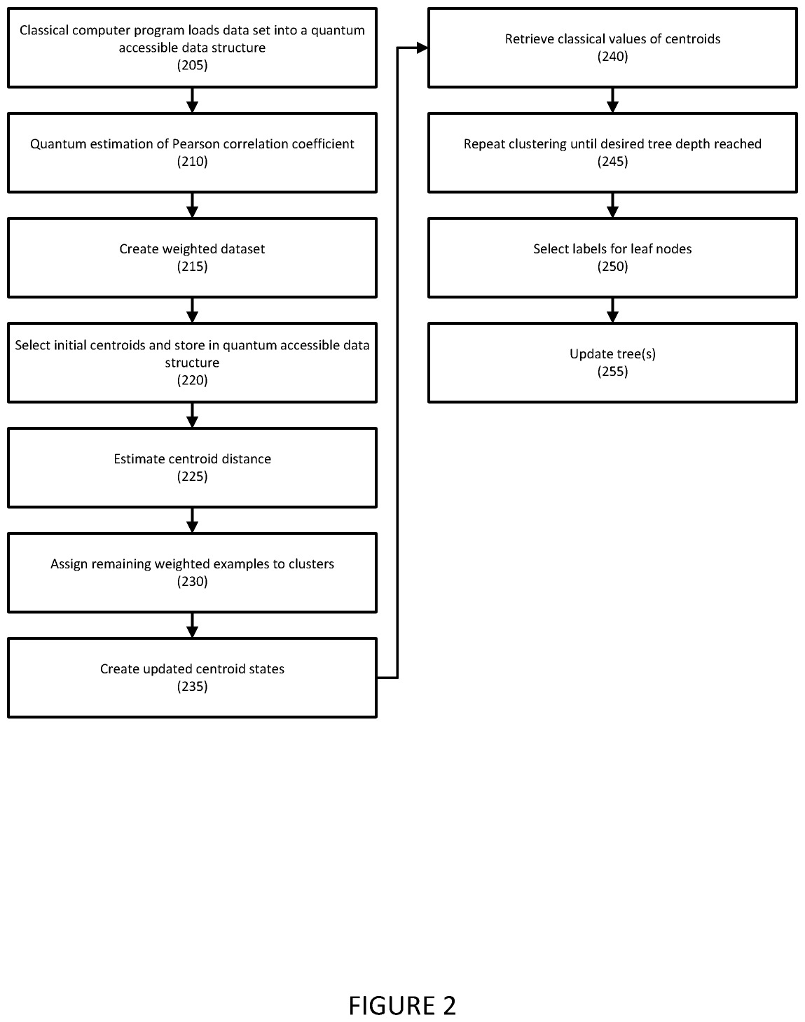

Referring to FIG. 2, a method for decision tree construction using quantum algorithms is disclosed according to an embodiment.

In step 205, a classical computer program may load a dataset into a quantum accessible data structure. For example, dataset X may be the input containing N training examples (e.g., training examples made with d features) and Y labels. The dataset may be loaded into a quantum accessible data structure, which may be stored in a quantum read only memory and accessed via superposition. The data structure may be leveraged to create amplitude encoded states (e.g., the quantum representation of the vectors) with a time complexity that scales polynomial in logarithm of N, where N is the number of training examples.

In one embodiment, the dataset X may be considered to be a matrix having N rows containing the training examples and d columns containing the features. With this data structure, embodiments may create N data structures, such as tree-like data structures, that may be indexed from 1 to N.

The quantum accessible data structures store information about the training examples. The training examples may be vectors with components that are real numbers that can be described by a positive number and a sign. Each of these vectors has a norm. There are different ways of storing the data. One example is using a tree-like data structure, the leaf nodes of each tree store the norms of each of the components of the vectors along with its sign, and the non-leaf nodes store the sum of the norms on the children nodes such that the root node stores the norm of that training example.

Once the dataset is loaded into the quantum accessible data structure, the structure may be accessed by the classical computer program using a communication channel between the classical computer and the quantum computer. For example, the classical computer program may access the data structure by a single index in which the amplitude encoded state corresponding to one specific training example is obtained, or by a superposition over indices in which the superposition of the training examples is obtained as amplitude encoded quantum state.

In step 210, the quantum computer program may perform quantum estimation of Pearson correlation coefficient, and, in step 215, may create a weighted dataset. In one embodiment, the quantum computer may calculate the Pearson correlation coefficient between each feature vector (i.e., a column of the matrix) from the dataset and the target label to assess the relative feature importance when predicting the output label. Thus, each feature vector may have a length N, and there may be d feature vectors.

For example, the quantum computer program may perform quantum estimation of Pearson correlation coefficient with amplitude encoded quantum states using, for example, the SWAP test, where the circuit runtime scales as [symbol] (log N/∈²), where ∈ is the error in the estimation of Pearson correlation coefficient. Examples of the SWAP test are disclosed in Barenco et al., “Stabilization of Quantum Computations by Symmetrization,” SIAM Journal on Computing. 26 (5): 1541-1557 (1997) and Buhrman et al., “Quantum Fingerprinting,” Physical Review Letters. 87 (16): 167902 (2001) and Fanizza et al., “Beyond the Swap Test: Optimal Estimation of Quantum State Overlap”, Phys. Rev. Lett. 124, 060503 (2020), the discloses of which are hereby incorporated, by reference, in their entireties. This is an exponential speedup over existing classical methods. In another embodiment, the SWAP test may be followed by an amplitude amplification procedure. In this case, the runtime scales better with the error E as it scales as log N/E.

Upon obtaining the correlation coefficients w(j) for each feature j ∈[d], embodiments may create a correlation coefficient vector of size d having elements that are each of these w(j). Then the correlation coefficient vector may be loaded into the quantum accessible data structure. This may be done by creating a separate data structure, such as a tree-like data structure. For every new data stored in the quantum accessible data structure, another data structure may be created and accessed by the classical computer program as an amplitude encoded quantum state. Each data structure may be loaded in the same way that the training examples were loaded.

Next, the training examples may be multiplied by the correlation coefficient vector so as to create a weighted dataset. Embodiments may apply the CONTROLLED NOT (CNOT) quantum operator between the first register that corresponds to the superposition of the amplitude encoded training examples as quantum states and the second register that corresponds to the amplitude encoded quantum state of the correlation coefficient vector.

The quantum computer may then measure the second register and store the output in the classical computer. The classical computer program may select the measurement outcome of the second register having an all zero state to obtain the weighted dataset that corresponds to multiplying the training examples by the correlation coefficient vector w:={w(1), . . . , w(d)}. The weighted dataset may then be stored in quantum states where the information is encoded in the amplitude. These quantum states may be used for quantum clustering.

Next, embodiments may perform supervised quantum clustering on the weighted dataset using the labels. In step 220, the classical computer program may select k initial centroids and store the centroids in the quantum accessible data structure using k data structures, such as tree-like structures, that are indexed from 1 to k. The centroids may then be retrieved in quantum superposition from the quantum accessible data structure as amplitude encoded states.

In step 225, the quantum computer then estimates the distance the weighted examples state to the centroids. Coherent quantum operations may be used to estimate the distance of the weighted examples with each of the centroid quantum states. For example, the quantum computer may calculate the inner product between each quantum state representing the weighted examples and the quantum states of the centroids. The highest this number, the closer the example is to the centroid.

In step 230, the quantum computer program may create k clusters by assigning the weighted examples state to the closest centroid quantum states based on finding the minimum distance between each weighted example and the k centroids. This creates a superposition of the N indices along with the labels that correspond to the cluster that the index belonging to the weighted example state is assigned to. Thus, there may be k labels (e.g., 1 to k).

In step 235, the quantum computer program may create the updated centroid quantum states by averaging the weighted example states in each cluster. This may be done by performing quantum matrix multiplication of the weighted training examples quantum state and the superposition of the indices belonging to a cluster.

In step 240, the quantum computer program may retrieve the classical values of the centroids. This may be done by the quantum computer measuring the centroid quantum states, and the results of the measurement results are processed by the classical computer program.

In step 245, the supervised clustering process may update the centroids iteratively. This process may be repeated until a maximum number of iterations are reached, or a certain convergence threshold is achieved, meaning that there is no significant shift between the centroid values obtained in one iteration and in the next iteration. This clustering process takes time that is polynomial in logarithm of N, where N is the number of training samples.

In step 250, the classical computer program may select labels for each of the leaf nodes of the tree. In the cluster corresponding to each leaf node, the classical computer program selects the label that is most common for the samples in the cluster. In one embodiment, the selection may be performed efficiently with complexity [symbol] (M log|Cₘ|), where M is the number of output classes and Cₘ is the number of examples in the cluster, using various quantum algorithms, such as the SWAP test, generalized projective measurements, etc.

In step 255, after the decision trees have been constructed with the N training examples, one or more of the decision trees may be updated. For example, a new dataset of new training examples (e.g., L new training examples) may be used to update the decision trees. Given new training examples L, where L<<N, embodiments may update the decision trees using the L+N training examples, and the total time to update the decision trees may be the sum of the time to load the L examples in the quantum accessible data structure in the classical computer that then is accessed by the quantum computer plus the time to construct the decision trees. This is approximately O′(poly−log(Nd)), where O′ hides other dependencies with other parameters.

Because this may be done with batches of data such that L<<N, the main contributor to the complexity is polylog(N), and this is an exponential speedup over classical methods for tree construction.

Embodiments may repeat the process of steps 205-250 with the new training examples and the other training examples. Thus, the process updates the trees using N+L training examples.

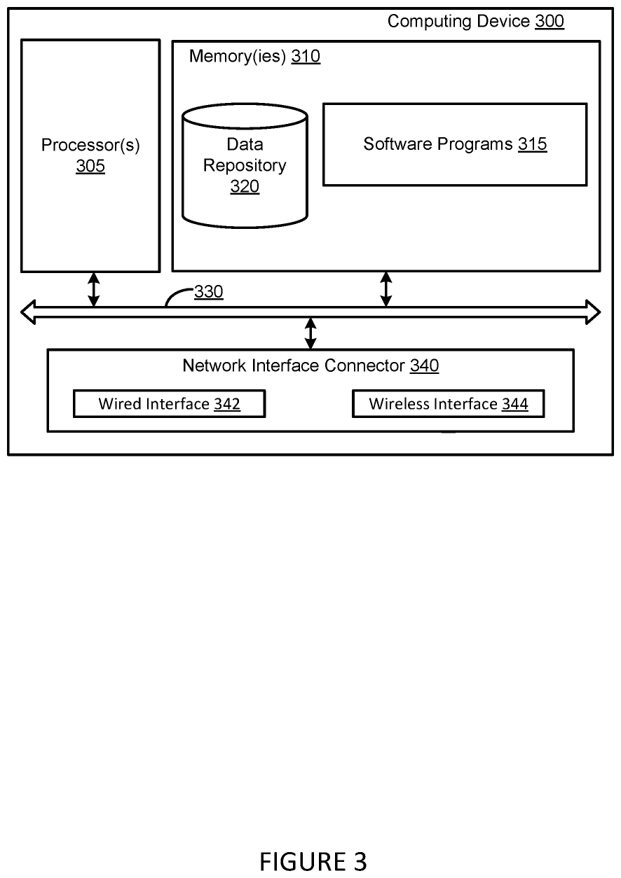

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for decision tree construction using quantum algorithms, comprising:
receiving, by a classical computer program, a dataset comprising a plurality of training examples, each of the plurality of training examples having a plurality of features;
loading, by a classical computer program, the dataset into a quantum accessible data structure;
providing, by the classical computer program, the quantum accessible data structure to a quantum computer, wherein the quantum computer is configured to perform quantum estimation of a Pearson correlation coefficient on the dataset in the quantum accessible data structure to create a weighted dataset;
clustering, by the classical computer program and the quantum computer, each of the plurality of training examples in the weighted dataset into one of a plurality of clusters; and
selecting, by the classical computer program, a label for each of the plurality of clusters.

2. The method of claim 1, wherein the dataset further comprises a plurality of labels.

3. The method of claim 1, wherein the quantum accessible data structure is stored in quantum read-only memory and is accessed via superposition.

4. The method of claim 1, wherein the quantum computer stores the training examples in the quantum accessible data structure as amplitude encoded quantum states.

5. The method of claim 1, wherein the Pearson correlation coefficient is estimated between each feature vector in the quantum accessible data structure and a target label, wherein each feature vector comprises the features for each training example.

6. The method of claim 1, wherein the quantum computer estimates the Pearson coefficient using the SWAP test and amplitude amplification.

7. The method of claim 1, wherein the step of quantum clustering on the weighted dataset comprises:
selecting, by the classical computer program, initial centroids for the weighted dataset and storing the centroids in the quantum accessible data structure;
storing, by the classical computer program, the initial centroids in the quantum accessible data structure; and
communicating, by the classical computer program, the quantum accessible data structure with the initial centroids to the quantum computer, wherein the quantum computer is configured to estimate a distance of each training example in the weighted dataset to the initial centroids, to assign each training example to one of a plurality of clusters based on the distances, and to update the initial centroids by averaging the training examples in each cluster.

8. The method of claim 7, wherein the quantum computer is configured to repeat the estimating, the assigning, and updating until a maximum number of iterations has occurred or convergence is achieved.

9. The method of claim 1, further comprising:
receiving, by the classical computer program, a new dataset comprising a plurality of new training examples, each of the plurality of new training examples having a plurality of new features;
loading, by a classical computer program, the new dataset into the quantum accessible data structure;
providing, by the classical computer program, the quantum accessible data structure to a quantum computer, wherein the quantum computer is configured to perform quantum estimation of a new Pearson correlation coefficient on the dataset in the quantum accessible data structure to create a new weighted dataset;
supervised clustering, by the classical computer program and the quantum computer, the training examples and the new training examples in the new weighted dataset into a plurality of clusters; and
selecting, by the classical computer program, a new label for each of the plurality of clusters.

10. A system, comprising:
a classical computer executing a classical computer program; and
a quantum computer in communication with the classical computer program;
wherein:
the classical computer program is configured to receive a dataset comprising a plurality of training examples, each of the plurality of training examples having a plurality of features;
the classical computer program is configured to load the dataset into a quantum accessible data structure;
the classical computer program is configured to provide the quantum accessible data structure to the quantum computer;
the quantum computer is configured to perform quantum estimation of a Pearson correlation coefficient on the dataset in the quantum accessible data structure to create a weighted dataset;
the quantum computer program is configured to perform supervised quantum clustering of each of the plurality of training examples in the weighted dataset into one of a plurality of clusters; and
the classical computer program is configured to select a label for each of the plurality of clusters.

11. The system of claim 10, wherein the dataset further comprises a plurality of labels.

12. The system of claim 10, wherein the quantum accessible data structure is stored in quantum read-only memory and is accessed via superposition.

13. The system of claim 10, wherein the quantum computer is configured to store the training examples in the quantum accessible data structure as amplitude encoded quantum states.

14. The system of claim 10, wherein the Pearson correlation coefficient is estimated between each feature vector in the quantum accessible data structure and a target label, wherein each feature vector comprises the features for each training example.

15. The system of claim 10, wherein the quantum computer estimates the Pearson coefficient using the SWAP test and amplitude amplification.

16. The system of claim 10, wherein the classical computer program is further configured to select initial centroids for the weighted dataset and storing the centroids in the quantum accessible data structure, to store the initial centroids in the quantum accessible data structure, and to communicate the quantum accessible data structure with the initial centroids to the quantum computer, and the quantum computer is further configured to estimate a distance of each training example in the weighted dataset to the initial centroids, to assign each training example to one of a plurality of clusters based on the distances, and to update the initial centroids by averaging the training examples in each cluster.

17. The system of claim 16, wherein the quantum computer is configured to repeat the estimating, the assigning, and updating until a maximum number of iterations has occurred or convergence is achieved.

18. The system of claim 10, wherein:
the classical computer program is further configured to receive a new dataset comprising a plurality of new training examples, each of the plurality of new training examples having a plurality of new features, to load the new dataset into the quantum accessible data structure, and to provide the quantum accessible data structure to a quantum computer, wherein the quantum computer is configured to perform quantum estimation of a new Pearson correlation coefficient on the dataset in the quantum accessible data structure to create a new weighted dataset;
the quantum computer is further configured to perform supervised clustering of the training examples and the new training examples in the new weighted dataset into a plurality of clusters; and
the classical computer program is further configured to select a new label for each of the plurality of clusters.
